(19) United States
(12) Patent Application Publication
(10) Pub. No.: US 2026/0235312 A1
(43) Pub. Date: Aug. 13, 2026

(54) HVAC SYSTEM WITH ADAPTIVE PARAMETER UPDATE FOR MODEL BASED CONTROL

(71) Applicant: Tyco Fire & Security GmbH, Neuhausen am Rheinfall (CH)

(72) Inventors: Daniel J. Brandt, Hartland, WI (US); John H. Burroughs, Wauwautosa, WI (US); Christopher R. Amundson, Grafton, WI (US)

(21) Appl. No.: 19/053,027

(22) Filed: Feb. 13, 2025

(51) Int. Cl. F24F 11/63; F24F 130/00

(52) U.S. Cl. CPC F24F 11/63; F24F 2130/00

(57) ABSTRACT

A system for model-based control of building systems. The system identifies sets of parameters that describe the behavior of a building system proximate respective operating points. During control, the system of determines an operational set of parameters describing the behavior of the building system near a current operating point by performing interpolation using the sets of parameters for the respective operating points. The system uses the operational set of parameters to perform the model-based control and determine a control action to communicate to the actuators of the building system. The system may also determine an appropriate time to update the operational set of parameters based on the current values of the operational set of parameters.

### BACKGROUND

The present disclosure relates generally to building management systems. The present disclosure relates more particularly to model-based control methodology for nonlinear systems.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS® building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One embodiment of the present disclosure relates to a method for controlling heating, ventilation, and air conditioning (HVAC) equipment of a HVAC system to affect a controlled physical state or condition of an environment. The method includes obtaining a plurality of sets of parameters for a predictive model of the HVAC system corresponding to a plurality of respective operating points of the HVAC system, the plurality of sets of parameters characterizing dynamic behavior the HVAC system at the plurality of respective operating points. The method also includes generating an interpolated set of parameters for the predictive model of the HVAC system for an interpolation operating point of the HVAC system, the interpolated set of parameters generated by interpolating between the plurality of sets of parameters based on the interpolation operating point relative to the plurality of respective operating points. The method also includes generating designated values for one or more control inputs to the HVAC equipment by performing a model-based control process using the interpolated set of parameters and operating the HVAC equipment to affect the controlled physical state or condition of the environment using the designated values for the one or more control inputs.

In some embodiments, generating the designated values of the one or more control inputs comprises performing a model predictive control process.

In some embodiments, an operating point of the plurality of respective operating points comprises at least one of a value for the controlled physical state or condition of the environment or values for one or more other physical states or conditions of the environment.

In some embodiments, the plurality of sets of parameters corresponding to the plurality of respective operating points are determined using training data including a training value for the controlled physical state or condition of the environment or training values for the one or more other physical states or conditions of the environment. The training data used to determine an identified set of parameters of the plurality of sets of parameters is selected based on at least one of (i) a first proximity criterion between the training value for the controlled physical state or condition of the environment and the value for the controlled physical state or condition of the environment for the respective operating point corresponding to the identified set of parameters or (ii) a second proximity criterion between the training values for the one or more other physical states or conditions of the environment and the values for the one or more other physical states or conditions of the environment for the respective operating point corresponding to the identified set of parameters.

In some embodiments, the method also includes generating at least a portion of the training data by simulating a nonlinear system representing at least one of the HVAC equipment or the environment.

In some embodiments, generating the interpolated set of parameters for the predictive model includes generating a hyperplane in an n-dimensional space of the operating point.

In some embodiments, obtaining the plurality of sets of parameters for the predictive model includes optimizing a system identification objective function.

In some embodiments, the method also includes intermittently updating the interpolated set of parameters for the predictive model.

In some embodiments, the method also includes calculating a time constant of the predictive model based on the interpolated set of parameters for the predictive model and determining a next time the interpolated set of parameters for the predictive model are to be updated based on the time constant.

Another embodiment of the present disclosure relates to a heating, ventilation, and air conditioning (HVAC) system to affect a controlled physical state or condition of an environment. The HVAC system includes one or more memory devices having instructions stored thereon that, when executed by one or more processors, cause the one or more processors to perform operations. The operations include calculating estimated values of one or more parameters of a model that relates one or more control inputs and a set of physical states or conditions to the controlled physical state or condition of the environment by interpolating the one or more parameters of the model based at least on (i) current values of the set of physical states or conditions and (ii) a set of values of the one or more parameters of the model for respective operating values of the set of physical states or conditions, wherein the set of physical states or conditions comprises states or conditions of at least one of HVAC equipment or the environment. The operations also include generating designated values for the one or more control inputs to the HVAC equipment by performing a model-based control process using the estimated values of the one or more parameters and operating the HVAC equipment to affect the controlled physical state or condition of the environment using the designated values for the one or more control inputs.

In some embodiments, generating the designated values of the one or more control inputs comprises performing a model predictive control process.

In some embodiments, wherein the set of values of the one or more parameters of the model for the respective operating values of the one or more control inputs or the respective operating values of the set of physical states or conditions are determined using training data including training values of the one or more control inputs, training values of the set of physical states or conditions, and training values of the controlled physical state or condition of the environment. The training values of the set of physical states or conditions satisfy a second proximity criterion with the respective operating values of the set of physical states or conditions.

In some embodiments, the operations also include generating at least a portion of the training data by simulating a nonlinear system representing at least one of the HVAC equipment or the environment.

In some embodiments, the model that relates the one or more control inputs and the set of physical states or conditions to the controlled physical state or condition of the environment comprises at least two submodels, wherein a first submodel of the at least two submodels generates a setpoint or a constraint that is an input to a second submodel of the at least two submodels.

In some embodiments, the HVAC equipment comprises at least two controllers. A first controller of the at least two controllers generates a setpoint or a constraint that is an input to a second controller of the at least two controllers

In some embodiments, the operations further also include calculating a time constant of the model based on the estimated values of the one or more parameters of the model and determining a next time the estimated values are to be updated based on the time constant.

Another embodiment of the present disclosure relates to a heating, ventilation, and air conditioning (HVAC) system to affect a controlled physical state or condition of an environment, the HVAC system. The system includes one or more memory devices having instructions stored thereon that, when executed by one or more processors, cause the one or more processors to perform operations. The operations include calculating estimated values of one or more parameters of a model that relates one or more control inputs and a set of physical states or conditions to the controlled physical state or condition of the environment by interpolating the one or more parameters of the model. The operations also include determining a next time to update the estimated values of the one or more parameters of the model based on the estimated values of the one or more parameters. The operations also include generating designated values for the one or more control inputs to HVAC equipment by performing a model-based control process using the estimated values of the one or more parameters and operating the HVAC equipment to affect the controlled physical state or condition of the environment using the designated values for the one or more control inputs.

In some embodiments, interpolating the one or more parameters of the model is based at least on a set of values of the one or more parameters of the model for respective operating values of the set of physical states or conditions.

In some embodiments, generating the designated values of the one or more control inputs includes performing a model predictive control process.

In some embodiments, the set of values of the one or more parameters of the model for the respective operating values of the set of physical states or conditions is determined using training data including training values of the one or more control inputs, training values of the set of physical states or conditions, and training values of the controlled physical state or condition of the environment. The training values of the set of physical states or conditions satisfy a second proximity criterion with the respective operating values of the set of physical states or conditions.

This summary is illustrative only and should not be considered limiting.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 is a schematic block diagram of a system for model-based control of a nonlinear system, according to some embodiments.

FIG. 6 is a data flow diagram illustrating the flow of data through the system of FIG. 5, according to some embodiments.

FIG. 7 is a schematic of an electrical equivalent circuit of a fan coil supplying a heating or cooling to a zone, according to some embodiments.

FIG. 8 is a flow of operations for controlling heating, ventilating, and air conditioning (HVAC) equipment based on interpolated model parameters, according to some embodiments.

FIG. 9 is a flow of operations for generating models and/or model parameters to be used during the controlling of FIG. 8, according to some embodiments.

### DETAILED DESCRIPTION

### Overview

Referring generally to the FIGURES, systems and methods for model-based control of nonlinear systems are disclosed. Model-based control of nonlinear systems can be hindered by at least two issues: (i) the model used to generate control actions may not be accurate in some regions of the nonlinear system's operation, and (ii) if a model capable of representing all regions of the control domain is used, the computational effort to generate the control actions may be high, making real time control impractical or costly, especially on edge computer hardware.

The systems and methods described herein use multiple models, each trained using data from within a specific region of the nonlinear system's operation. During operation, model parameters for the model-based control may be obtained based on the model parameters of the trained models. For example, the parameters from models trained with data near the current operating condition of the nonlinear system may be used in an interpolation process to determine model parameters for the generation of control actions. The determined model parameters may be an accurate representation of the nonlinear system near the current operating conditions and allow for practical computation of the model-based control.

Advantageously, the systems and methods described herein can be used to control the nonlinear systems of HVAC equipment and/or the spaces (e.g., buildings, zones, campuses, etc.) that the equipment serves. For example, chillers, fan coils, air handling units (AHUs), and variable refrigerant flow (VRF) systems may be controlled as described herein.

### Building and Building Management System

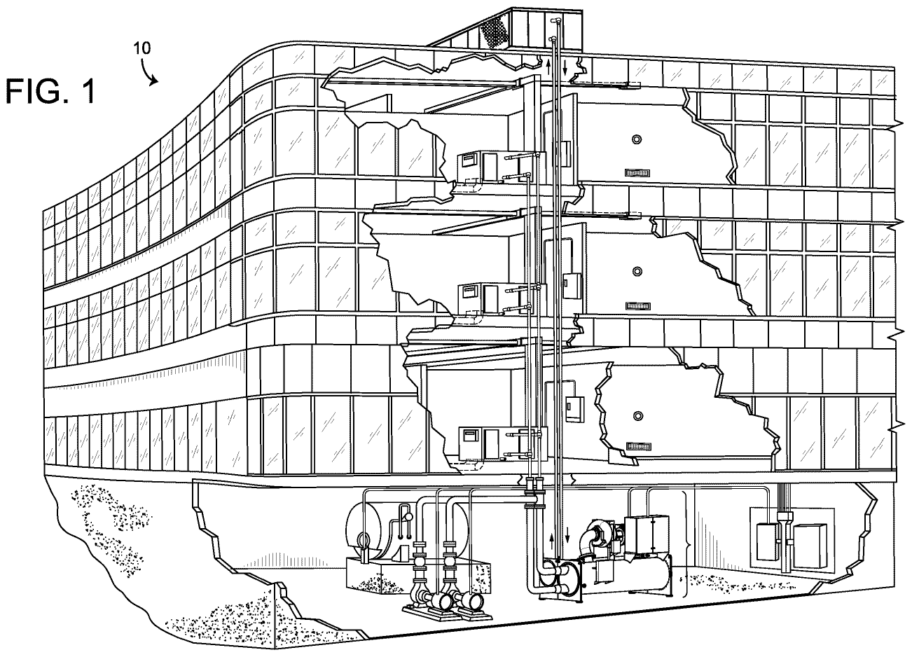

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

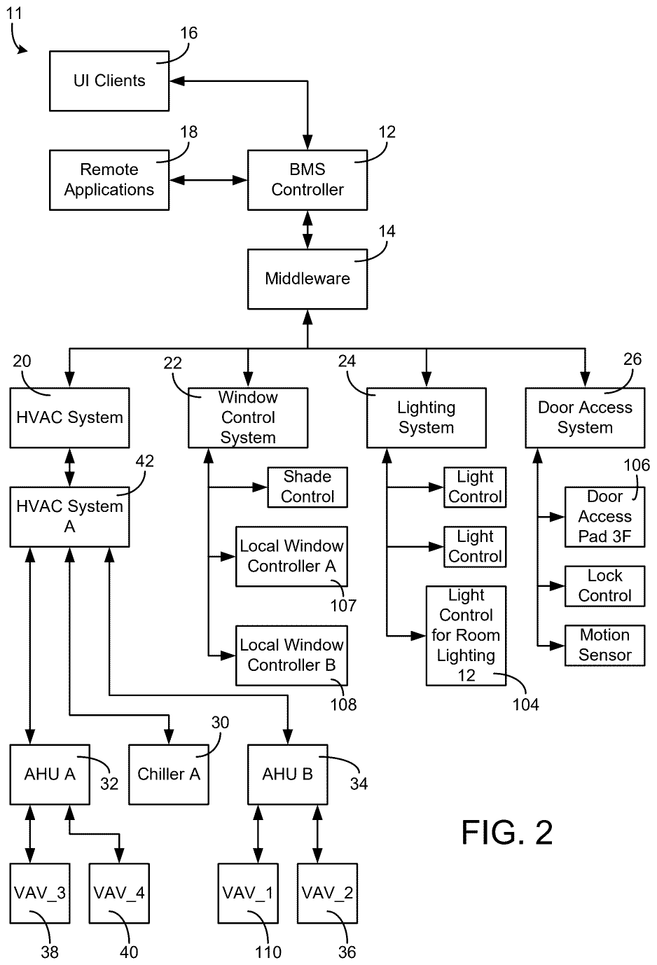

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

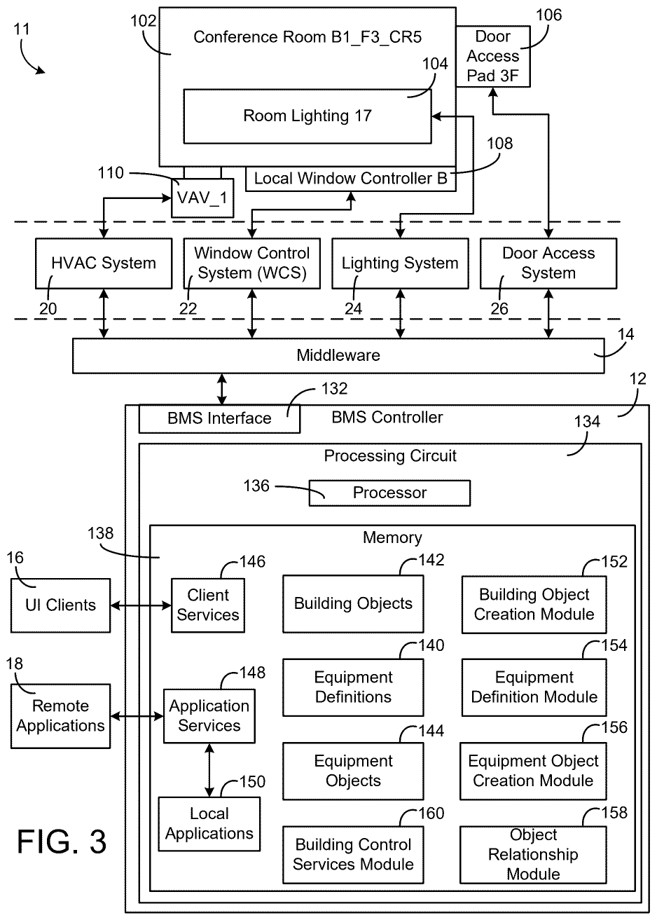

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, a NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

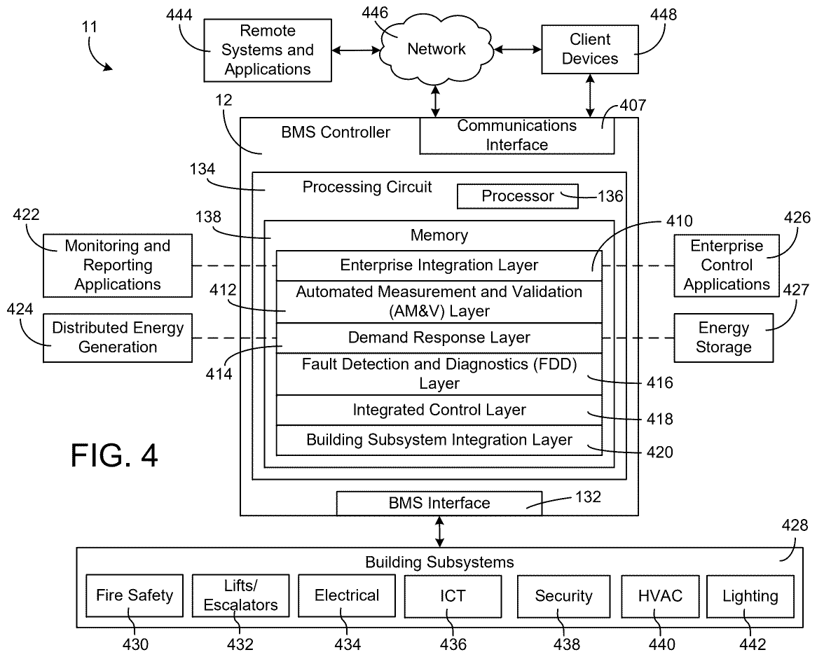

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Parameter Update for Model-Based Control

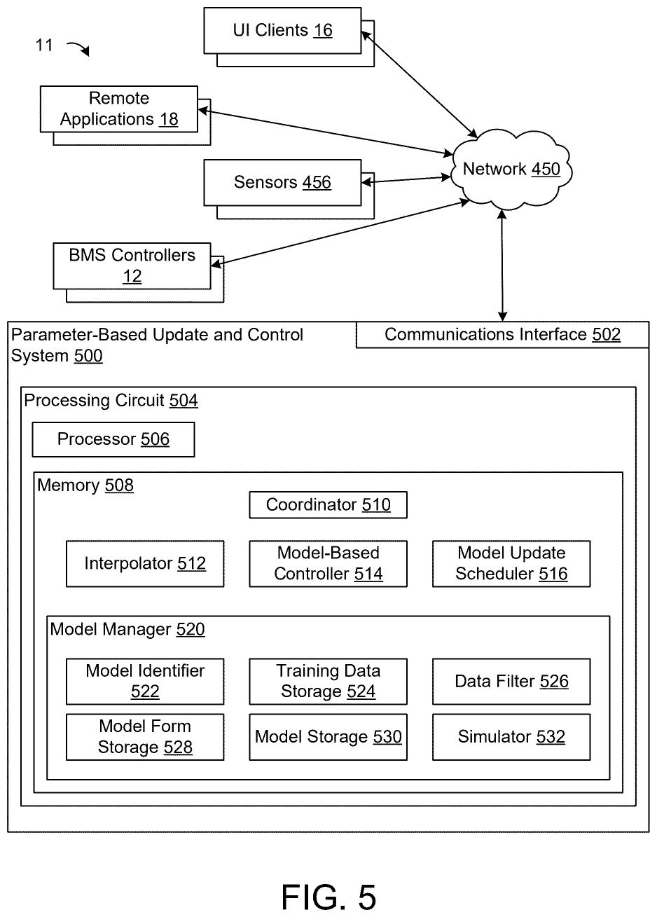

FIG. 5 shows BMS 11 configured with a parameter-based update and control system 500 according to some embodiments. The BMS 11 is shown to include UI clients 16, remote applications 18, other BMS controllers 12, and one or more sensors 456 in addition to the parameter-based update and control system 500 communicably connected via a network 450. The parameter-based update and control system 500 is to maintain several models (e.g., or set of parameters) for the system that describe system behavior in an operating region proximate a corresponding (e.g., or respective) operating point. The parameter-based update and control system 500 may perform interpolation to find an operational model or set of parameters describing system behavior at an operational operating point different than any of the corresponding operating points for the several models. For example, the operational operating point may represent a current operating point or a future operating point at which the system is expected to arrive. Model-based control can be performed using the operational model. In some embodiments, the operational model or set of parameters are updated at a scheduled time based on the current operating set of parameters.

The system controlled by the parameter-based update and control system 500 may be complex. For example, the system may be difficult to model because of system nonlinearities, a large number of parameters representing full system behavior, and physical equations for which an analytical solution does not exist. Additionally, even if the system can be modeled accurately, it may be difficult to perform necessary calculations to perform model-based control based on the complex model. Advantageously, the parameter-based update and control system 500 may represent the system behavior with several less complex models (e.g., linear, fewer parameters, etc.) and sets of parameters at different operating points. The less complex models may describe the behavior of the system under control for a local region proximate the different operating points. The model-based control process may be performed for a less complex model having a set of parameters based on the sets of parameters stored for operating points proximate an operational (e.g., current or predicted) operating point.

The one or more sensors 456 may be configured to provide telemetry to the parameter-based update and control system 500 and the other BMS controllers 12 of the BMS 11. The one or more sensors 456 may provide sensor data over the network 450. Non-limiting examples of sensors that may be used by the BMS 11 include building static pressure sensors, duct static pressure sensors, fluid flow sensors, rotational speed sensors, temperature measurement sensors, or any other sensor that may be used to provide information to the parameter-based update and control system 500. The measurements of the one or more sensors 456, for example, may be used to generate training data for model identification and/or used as inputs to the control process. In some embodiments, the one or more sensors 456 communicate measurements periodically (e.g., every minute, every quarter hour, etc.). Additionally or alternatively, the one or more sensors 456 may communicate measurements anytime the value the sensor measures changes by a predefined amount (e.g., the change-of-value (COV) threshold).

The network 450 may be configured to provide communication between the various components of the BMS 11. The network 450 can include routers, switches, antennas, computers, and any other hardware required to communicate information between the components of the BMS 11 (e.g., from the one or more sensors 456 to the parameter-based update and control system 500 and/or from the parameter-based update and control system 500 to any of the equipment or actuators thereof). A portion of the network 450 may be wireless and/or a portion of the network 450 may be wired. The network 450 can include one or more networks with routers to facilitate data transfer between the different networks. For example, a number of the one or more sensors 456 may be connected to the other BMS controllers 12 on a sensor network, and the BMS controllers 12 may communicate the measurements of the number of the one or more sensors 456 over a second network (e.g., a network using internet protocol).

The parameter-based update and control system 500 is shown to include a communications interface 502 and a processing circuit 504. The communications interface 502 may be configured to provide communications over the network 450. The communications interface 502 may share one or more communications protocols with the other components of the BMS 11 to allow the parameter-based update and control system 500 to (i) send information to one or more components of the BMS 11 and (ii) to receive information from one or more components of the BMS 11. The processing circuit 504 may include one or more processors 506 and memory 508. The memory 508 may be configured to store the sets of parameters used by the parameter-based update and control system 500 to perform the control processes, training data, and model forms (e.g., model types). The memory 508 may also include instruction sets (e.g., computer code) that, when executed by the one or more processors 506, cause the one or more processors 506 to perform operations to provide the functionality of the parameter-based update and control system 500 as described herein.

The one or more processors 506 may be a general purpose or specific purpose processors, an application specific integrated circuit (ASIC), one or more field programmable gate arrays (FPGAs), a group of processing components, or other suitable processing components. The one or more processors 506 may be configured to execute computer code and/or instructions stored in the memory 508 or received from other computer readable media (e.g., CDROM, network storage, a remote server, etc.). The one or more processors 506 may be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memory 508 may include one or more devices (e.g., memory units, memory devices, storage devices, etc.) for storing data and/or computer code for completing and/or facilitating the various processes described in the present disclosure. The memory 508 may include random access memory (RAM), read-only memory (ROM), hard drive storage, temporary storage, non-volatile memory, flash memory, optical memory, or any other suitable memory for storing software objects and/or computer instructions. The memory 508 may include database components, object code components, script components, or any other type of information structure for supporting the various activities and information structures described in the present disclosure. The memory 508 may be communicably connected to the one or more processors 506 and can include computer code for executing (e.g., by the one or more processors 506) one or more processes described herein.

The memory 508 of the parameter-based update and control system 500 is shown to include a coordinator 510, an interpolator 512, a model-based controller 514, a model update scheduler 516, and a model manager 520. The model manager 520 may include storage capability for storing the models used by the parameter-based update and control system 500 to perform interpolation, as well as the training data and the forms of the models that can be used for performing system identification to obtain sets of parameters (e.g., a model). For example, the model manager is shown to include a training data storage 524, a model form storage 528, and a model storage 530. The model manager may also include a model identifier 522, a data filter 526, and a simulator 532.

The instruction sets and/or functionality of the parameter-based update and control system 500 may be distributed across any number of hardware units. For example, a first portion of the parameter-based update and control system 500 may be stored and/or executed on a node computer in a cloud architecture, and a second portion of the parameter-based update and control system 500 may be stored and/or executed on an edge device such as a BMS controller 12. In some embodiments, there may be more than one instantiation of any of the instruction sets currently operating on the one or more processors 506 (e.g., in parallel). The number of parallel instances of any of the features or functionality of the parameter-based update and control system 500 may scale based on the current demand for that feature or functionality. For example, if several models are being identified, several instances of the model identifier 522 may execute in parallel.

The coordinator 510 may be configured to control the timing and flow of data through the other circuitry of the parameter-based update and control system 500. For example, the coordinator 510 may cause the modules or circuits to execute in a specific order to perform the function of the parameter-based update and control system 500. In some embodiments, the coordinator 510 may route the information and/or outputs of other modules that are dependent on the information or use the information as an input. The coordinator 510, for example, may execute two modes of operation: an online or controlling mode and an offline or training mode. In some embodiments, the training mode is performed in one hardware architecture (e.g., in the cloud) and the controlling mode is performed in another hardware device (e.g., a BMS controller 12). The coordinator 510 may be distributed and/or duplicated on the various hardware components that make up the parameter-based update and control system 500.

The control mode may include actively controlling the equipment to affect a variable or condition of the system being controlled (e.g., maintaining a supply air temperature at a particular setpoint, etc.). The control mode may include receiving measurements from the one or more sensors 456 and using the measurements to (i) determine an operational set of parameters that can be used to describe system behavior around the respective operating points, and (ii) determine a control action using the measurements and the operational set of parameters. For example, during the control mode, the parameter-based update and control system 500 may determine the current operating point based on the measurements from the one or more sensors 456 and current activation levels sent to the actuators by the parameter-based update and control system 500. The parameter-based update and control system 500 may also predict operating points expected in the future.

The training mode may include determining the models (e.g., the sets of parameters) that are used during the control mode. During the training mode, a number of interpolation operating points are chosen to be the basis of the interpolation performed by the parameter-based update and control system 500. The interpolation operating points may be chosen, for example, to form a grid over the region of operation within which the operating points of the system are expected to remain. Training data may be acquired from locations proximate to the interpolation operating points and used to generate models (e.g., perform parameter identification for the models) and arrive at interpolation sets of parameters that correspond to the respective interpolation operating points.

In some embodiments, the online mode uses the interpolator 512 to determine an operational set of parameters for each of the respective current and/or predicted operating points. The operational set of parameters may be provided to the model-based controller 514 to determine a control action based on the operational set of parameters.

The interpolator 512 may be configured to generate an operational set of parameters, θₒ, corresponding to an operational (e.g., current or predicted) operating point, qₒ. The interpolator 512 may perform interpolation using a number of interpolation sets of parameters θᵢ ∀i=1 . . . N and the corresponding operating points qᵢ ∀i=1 . . . N, where N is the number of interpolation sets of parameters and operating points available to use during interpolation. A set of parameters, θ, may be parameters of a model used by the model-based controller 514. The elements of the set of operational parameters may have physical meaning, for example, an element may represent a thermal capacitance of the building or a heat transfer coefficient or a value derived from multiple physical properties. The elements of the set of operational parameters may have no physical meaning, for example, an element of a general state-space system or a weight of a neural network model. The elements of an operating point, q, may include measurements, y, related to the current state of the system under control and/or actuation levels, u, sent to the actuators.

In some embodiments, the interpolator 512 selects a number of interpolation operating points near the operational operating point (e.g., current and/or predicted) and fits an n-dimensional (e.g., where n is the dimension of the operating points) hyperplane for each element of the interpolation sets of parameters. Any number of interpolation operating points may be used to determine the hyperplane. For example, if the number of interpolation operating points is equal to n+1, a hyperplane that coincides with each point can be found; or if the number of interpolations operating points is greater than n+1, a least squares fit can be used to find the hyperplane. In some embodiments, the interpolator 512 may perform extrapolation in addition to interpolation, for example, if an operational operating point is outside the set of all points.

In some embodiments, the model-based controller 514 is configured to determine the current operating point using the current measurements and/or actuation levels and/or a predicted operating point using predicted measurements and/or actuation levels. The interpolator 512 may be configured to acquire the operating points and generate an operational set of parameters based on the one or more current and/or predicted operating points.

Interpolation may be performed by the interpolator 512 using an interpolation algorithm designed to generate multidimensional outputs. For example, the interpolator 512 may perform multivariate spline interpolation, use radial basis function interpolation, or perform Gaussian process regression. Additionally or alternatively, the interpolator 512 may be configured to execute interpolation for each element of the set of parameters independently using an interpolation algorithm that generates a scalar output (e.g., linear interpolation, polynomial interpolation, etc.).

The model-based controller 514 may be configured to determine appropriate control actions to affect a variable or condition of a building or building environment. For example, the model-based controller 514 may perform model predictive control (MPC). MPC may seek to determine a best sequence of control actions over a predictive horizon and execute the first action of the sequence before repeating the optimization process for the set of predictions on a subsequent execution of the algorithm. MPC may optimize an objective function related to system behavior (e.g., minimize the cost of controlling the system, etc.). More information related to MPC of building systems and/or environments can be found in U.S. Pat. No. 9,436,179 granted on Sep. 6, 2016 and U.S. Pat. No. 10,175,681 granted on Jan. 8, 2019, the entire contents of both are herein incorporated by reference.

MPC may be computationally intensive, especially for complex systems (e.g., nonlinear systems, nonconvex systems, systems represented by a large number of parameters, etc.) and it may be difficult to perform the required operations in an acceptable amount of time when a model of the complex system is used. Advantageously, the parameter-based update and control system 500 may use models that have beneficial attributes (e.g., are convex, are linear, have a few parameters) and can describe the behavior of the system at least locally to an operating point. The model-based controller 514 may use the interpolator 512 as described herein to determine parameters for the models with the beneficial attributes based on several sets of parameters identified for different operating points. Using models with the beneficial attributes may allow the MPC controller to perform fewer computations and optimize the objective function in an acceptable amount of time (e.g., with small enough lag that the system can be controlled).

In some embodiments, the model-based controller 514 may use the operational set of parameters in the computation of the control action. A proportional-integral-derivative (PID) controller may be used by the model-based controller 514. The parameters of the PID controller (e.g., the proportional gain, the integral time, the derivative gain, etc.) may be based on the operational set of parameters. For example, one of the parameters of the operational set of parameters, θₒ, may be a time constant. The PI controller may directly use the operational value of the time constant (e.g., from the operational set of parameters) to determine the integral time of the PID controller. For example, the integral time of the controller may be set to half of the operational value of the time constant. The parameters of the PID controller may update each time the operational parameters, θₒ, are updated (e.g., by the interpolator 512) and may also be used by model-based controller 514.

The control actions determined by the model-based controller 514 may be communicated to the actuators of the equipment of the BMS 11. In some embodiments, the control actions determined by the model-based controller 514 are first communicated to the other BMS controllers 12. The control actions determined by the model-based controller 514 may be used to generate electric control signals (e.g., by the other BMS controllers 12 and/or the parameter-based update and control system 500) for the actuators of the equipment. The electric control signals may digital (e.g., the actuation level may be communicated to a smart actuator) or the electric control signals may be analog (e.g., a magnitude, frequency, duty cycle, or some other property of the electric control signal may be proportional to the actuation level). Actuators may refer to any device that affects a condition or variable of the system under control. The effect may either be direct (e.g., damper vane positions) or indirect (e.g., a stepper motor affecting damper vane positions). Nonlimiting examples of actuators include damper motors, fan speed control, relays, variable speed drives (e.g., for a compressor, or for a fan), impeller blade actuators on a compressor, a chiller, a boiler, etc.

The model update scheduler 516 may be configured to schedule a time to update the operational set of parameters (e.g., to execute the interpolator 512 based on a current operating point). The model update scheduler 516 may determine the time between updates based on the operational set of parameters. For example, a current time constant indicated by the operational set of parameters may be used to determine the time to update the operational set of parameters. If the time constant is large, the system may be expected to move within the region of operation slowly and thus require fewer updates of the operational parameters, and the time between updates can be increased or be large. If the time constant is small, more updates may be appropriate, and the time between updates can be shortened. Advantageously, the model update scheduler 516 causes the parameter-based update and control system 500 to execute the interpolator 512 and update the parameters used only when appropriate, potentially saving significant computational costs.

Additionally or alternatively, the model update scheduler 516 may be configured to schedule the next time for a parameter update or the time between parameter updates based on the gradient of the elements of the set of parameters with respect to the elements of the operating point. For example, the model update scheduler 516 may generate the Jacobian of the operational set of parameters, θₒ, with respect to the operational operating point, qₒ. The gradient or Jacobian may be approximated using the interpolation sets of parameters θᵢ ∀i=1 . . . N and the corresponding operating points qᵢ ∀i=1 . . . N, for example, by way of a finite difference equation using interpolation sets of parameters proximate the current operating point. If the operational set of parameters, θₒ, changes rapidly with respect to the operational operating point, qₒ, as indicated by the gradient and/or Jacobian, it may be appropriate to update the operational set of parameters more often or schedule the next time for a parameter update sooner.

In some embodiments, the model update scheduler 516 may trigger a parameter update based on current measurements. For example, if the operating point, using current measurements, satisfies a distance criterion with the operational operating point, the model update scheduler 516 may trigger a parameter update. The operational set of parameters may be generated similar to a change-of-value, for example, updating each time the operating point based on current measurement changes by a certain amount (e.g., satisfies the distance metric).

The model update scheduler 516 may also be configured to schedule an update of the interpolation sets of parameters, θᵢ ∀i=1 . . . N, (e.g., of the models) stored in the model storage 530. The interpolation sets of parameters may be updated periodically (e.g., on a repeated schedule such as each day, each week, etc.). Additionally or alternatively, the interpolation sets of parameters may be updated based on the amount of new training data that has been acquired during operation. In some embodiments, models for all respective interpolation operating points are updated together; alternatively, the models may be updated individually (e.g., when an amount of training data has been acquired for a particular respective interpolation operating point). The model update scheduler 516 may be configured to cause the model manager 520 to execute, for example, the model identifier 522 responsive to such conditions.

In some embodiments, executing the functionality of the training mode may include executing the model manager 520 to generate a number of interpolation sets of parameters for respective interpolation operating points. The data filter 526 may select data from the training data storage 524 that is associated with an interpolation operating point. The data selected may be used by the model identifier 522 to identify parameters related to a specific model form in the model form storage 528. Each interpolation set of parameters that is identified by the model identifier 522 may be stored in the model storage 530.

The training data storage 524 may be configured to maintain (e.g., store, save, etc.) a set of training data acquired during the operations of the system. The training data may include measurements, y, related to the current state of the system under control and/or actuation levels, u, sent to the actuators collected at the same or similar times. For example, each element of the measurements, y, and the control actions or actuation levels, u, may satisfy a timing criterion (e.g., all collected within a 30 second time period). A training sample may be for a particular time period. For example, a training sample may be represented by measurements, y_{t,training}, and by control actions, u_{t,training}, where the index t represents the time period of collection.

The training data storage 524 may be configured to discard data (e.g., not store the data) that is determined to potentially be incorrect in an aspect. The training data storage 524 may discard data that is outside the bounds for a particular measurement. The bounds, for example, may be statistically generated and represent a number of standard deviations away from the mean, median, or other measure of central tendency. The bounds may also be predefined based on expert knowledge of the system and/or what is physically possible. For example, if a temperature of a fluid flowing through a pipe is below the freezing point of that fluid, the measurements for that time period may be discarded. Additionally or alternatively, the training data storage 524 may discard data that is subject to an elevated amount of noise, changed by a large amount, or any other criterion indicative of a data error (e.g., a measurement or communication error).

The model form storage 528 may be configured to store different model forms for use by the model identifier 522 during training. A model form may include a parameterization of a model or model template. By combining a model form with a set of parameters (e.g., compatible with the model form) a model may be generated that is capable of describing the behavior of the system under control. A model form with an operational set of parameters may be used by the model-based controller 514 in order to calculate control actions. Additionally, a model form may be used with training data to obtain a best fit set of parameters for the particular model form. During operation, the model-based controller 514 and/or the model identifier 522 may request a model form from the model form storage 528.

The model storage 530 may be configured to store model parameters after being identified using the model identifier 522. For example, the model storage 530 may store the interpolation sets of parameters with their respective interpolation operating points. The interpolator 512 may request one or more sets of parameters from the model storage 530 to perform interpolation while obtaining the operational set of parameters.

In some embodiments, the system under control can be represented by a complex model (e.g., nonlinear, nonconvex, having many parameters). However, the model-based controller 514 may not be able to perform control computations for the complex model. It is possible to find a set of parameters for the complex model using the training data from the training data storage 524 and the model identifier 522. Parameter fitting can be performed during the training mode for the complex model. The parameters for the complex model may be capable of describing global behavior (e.g., all operating regions or all operating regions that the system under control may enter) or at least a larger range of operating regions than a simple model. The simulator 532 may be configured to obtain training data based on the complex model that can then be used to identify one or more of the simple models.

The simulator 532 may be configured to generate training data using a model of the system behavior. The training data generated by the simulator 532 may be used to generate training data for operational regions that the system did not enter naturally. The simulator 532 may use the complex model to fill regions of operation with training data so that a simpler model can be identified for that region. The simulator 532 may be configured to use any model form from the model form storage 528 to generate training data. For example, the simulator 532 may be configured to simulate state-space models of the form:

$${x}_{t + 1} = f ( {x}_{t} , {u}_{t} ; θ )$$

$${y}_{t} = h ( {x}_{t} , {u}_{t} ; θ )$$

where xₜ are the state variables of the system at time t, f(xₜ, uₜ; θ) represents the state update equation, and h(xₜ, uₜ; θ) represents the measurement equation.

The model identifier 522 may be configured to find a best fit set of parameters for a given model form and a set of training data. To find the best fit set of parameters, the model identifier 522 may generate an objective function that calculates the fit as a function of the set of parameters. For example, a least squares fit may be used as shown in:

$$J ( θ ) = {\sum }_{t = 1}^{T} {‖ {y}_{training} - {\hat{y}}_{t} ( {u}_{training} , θ ) ‖}^{2} ,$$

where ŷₜ(u_{training}, θ) represents an estimate of the measurement at time t given the actuation of the training data and a set of parameters. The model identifier 522 may be configured to minimize the objective function with respect to the parameters.

In some embodiments, the objective function may use a different norm (e.g., as an alternative to the 2-norm). For example, a 1-norm or an infinity-norm may be appropriate for certain parameter identification objectives. Additionally, the optimization of the objective function may be subject to various constraints on the values for the set of parameters. The parameters may have known bounds, for example, based on the physical meaning of the parameter. A parameter that represents a physical quantity (e.g., a capacitance or heat transfer coefficient) may be constrained to positive values. Lower and upper bounds may be known for some parameters. In some embodiments, the bounds of some parameters may depend on the value of other parameters. Such constraints may be written as:

$$A θ \leq 0 ,$$

for the case of linear constraints or

$$g ( θ ) \leq 0 ,$$

for the case of nonlinear constraints.

The model manager 520 may be configured to acquire (e.g., receive, select, generate, etc.) several interpolation operating points, each of which has an interpolation set of parameters that is to be identified by the model identifier 522. The model manager 520 may select the interpolation operating points based on a grid that is suitable for performing interpolation. In some embodiments, the grid may be irregular. For example, the grid may have a higher resolution is certain regions than in others. The grid may be of higher resolution in areas of the operating region where the system is expected to operate more often or where the respective best fit parameters are expected to change more rapidly as a function of the operating point. The interpolation operating points acquired by the model manager 520 may be communicated to the data filter 526 so that appropriate training data can be selected for the interpolation operating point.

The data filter 526 may be configured to select training data (e.g., from the training data storage 524) that satisfies a proximity criterion with a received operating point. For each interpolation operating point acquired by the model manager 520, the data filter 526 may select the appropriate training data (e.g., data that satisfies the proximity criterion with the interpolation operating point). The selected data may be communicated to the model identifier 522 for identification of parameters using the selected data. Identified parameters may be stored (e.g., in the model storage 530) as the interpolation set of parameters with the corresponding interpolation operating point for which the data filter 526 selected data. Each pair of the identified interpolation set of parameters and the corresponding interpolation operating point may be used by the interpolator 512 during interpolation to obtain an operational set of parameters for online controlling.

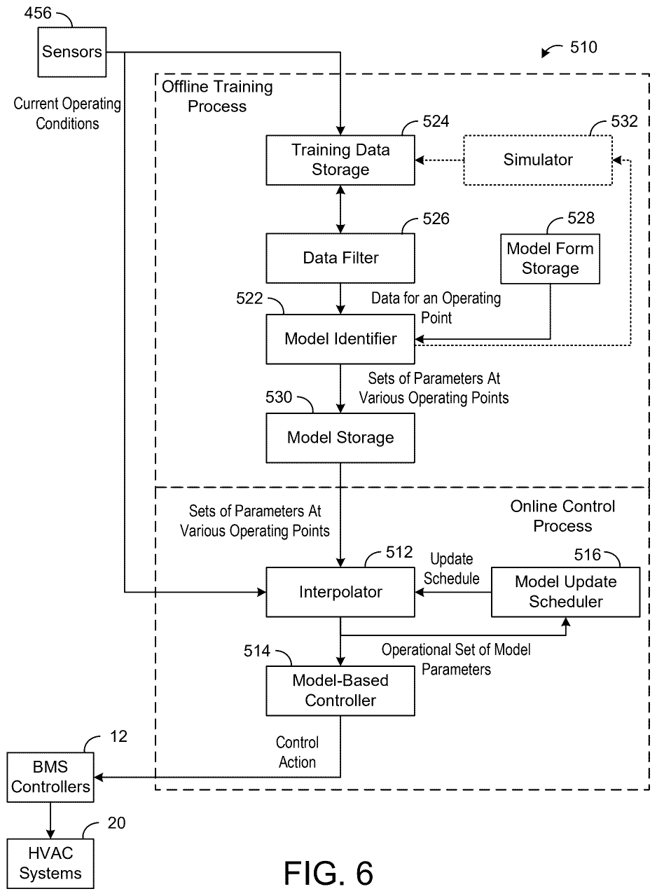

FIG. 6 shows the flow of data within the parameter-based update and control system 500, according to some embodiments. The flow of data and the timing of operations may be managed by the coordinator 510. As shown, the coordinator 510 may perform an offline training process (e.g., in the offline or training mode) and an online control process (e.g., in the online or the control mode). The two processes are coupled by the model storage 530. The model storage 530 saves the sets of parameters at various interpolation operating points that are then used by the interpolator 512 during the control process.

Sensor data may be collected and stored by the training data storage 524. During the offline training process, the data filter 526 may select, from the training data storage 524, data based on certain criteria. The data filter 526 may send a query to the training data storage 524 that is based on a particular interpolation operating point for which the model is currently being generated. For example, the query may include a criterion related to the proximity of the training data to the particular interpolation operating point. The training data storage 524 may find the training data that satisfies the proximity criterion of the query and respond with that data.

After receiving the data from the training data storage 524, the data filter may relay the training data to the model identifier 522. The model identifier 522 receives the training data and a model form (e.g., type or template) from the model form storage 528 with which to fit the data. The model identifier 522 may perform parameter identification, as described previously herein, in order to determine a set of operating parameters that can be associated with the particular interpolation operating point based upon which the training data was selected. The set of parameters identified (e.g., the best fit set of parameters) may be stored with the particular interpolation operating point in the model storage 530. The data flow may be repeated for each of the interpolation operating points determined by the model manager 520 to develop the multiple interpolation sets of parameters that are used by the interpolator 512 during the online process.

In some embodiments, an initial data flow is performed prior to identifying models for each of the interpolation operating points. Parameters for a more global, complex model may be identified first and used to generate training data. All of the training data in the training data storage 524 may be requested by the data filter 526 and sent to the model identifier 522 for identification of a complex (e.g., nonlinear, nonconvex, etc.) model. The complex model form may also be stored in the model form storage 528 with a simplified model that will be used to identify interpolation sets of model parameters. The model identifier 522 may identify the complex model and provide the complex model to the simulator 532 for data generation. Simulated data using the complex model can be used to augment the training data in the training data storage 524, for example, to add data for operating regions that are not represented in training data from the one or more sensors 456, but may be expected to occur during future online control. After the simulator 532 generates data, the offline training process's data flow can continue as described for each of the particular interpolation operating points defined by the model manager 520.

During the online control process, current data from the one or more sensors 456 is acquired by the interpolator 512. Based on the current operating point, defined by the current data from the one or more sensors 456, the interpolator 512 may generate a current operational set of parameters. The operational set of parameters may be found by interpolation using the current operating point and the interpolation sets of parameters for the corresponding interpolation operating points. The operational set of parameters may be communicated to the model-based controller 514 and the model-based controller 514 may generate control actions based on the operational set of parameters.

The control actions may also be communicated (e.g., by way of electric control signals) the BMS controller 12 and/or the HVAC systems 20. The control action may be communicated by the BMS controllers 12 to the HVAC systems 20. Additionally or alternatively, the parameter-based update and control system 500 may send the control action or electric control signals generated therefrom directly to the HVAC systems 20.

In some embodiments, the operational set of model parameters are additionally provided to the model update scheduler 516. The model update scheduler 516 may provide an update schedule or a next time to update the operational set of parameters to the interpolator 512. The next time to update the parameters may be based on the operational set of parameters that were most recently calculated by the interpolator 512. For example, the operational set of parameters may indicate that the operating point is expected to change rapidly and the operational set of parameters should be updated a short time from now or more often.

In some embodiments, two or more parameter-based update and control system 500 may be configured in a cascaded control architecture. For example, the output of one controller may provide a setpoint to another controller. Additionally or alternatively, the output of one controller may provide constraints to another controller. Cascaded control architectures may advantageously allow for two simpler controllers to provide control of equal or enhanced performance compared to a single more complex controller.

The parameter-based update and control system 500 may be cascaded using various methodologies, each methodology providing differing levels of code and component reuse. In some embodiments, cascaded control using the parameter-based update and control system 500 is provided by two independent instantiations of the parameter-based update and control system 500. In such a configuration, the two parameter-based update and control systems 500 do not share information other than the setpoint and/or constraints from the upstream controller to the downstream controller. In some embodiments, a single parameter-based update and control system 500 is instantiated in the cascaded control architecture, however various components may be duplicated (e.g., the model-based controller 514 and/or the model manager model manager 520). An instantiation of the model manager 520 may be associated with an instantiation of the model-based controller 514 to form a pair. Each pair may operate independently (e.g., have different sets of parameters and/or operating points), but share similar infrastructure provided by the parameter-based update and control system 500 (e.g., receiving measurements, etc.). For example, the interpolator 512 may be memoryless and perform interpolation for the interpolation operating points and the interpolation parameters for a first pair associated with the upstream controller independently from those of the second pair associated with the downstream controller. In some embodiments, there are two or more instantiations of the model-based controller 514 and other components are common for the parameter-based update and control system 500. For example, the set of parameters may include parameters for both of the model-based controllers 514. In some embodiments, the cascaded controller (e.g., all component parts) is treated as a single instantiation of the model-based controller 514. The parameters of both component parts may be found via the interpolator 512 and incorporated into a single model for a cascaded control.

Exemplary System for Model-Based Control with Adaptive Parameter Update

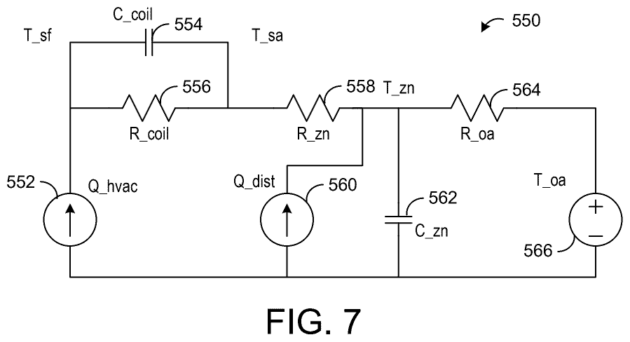

FIG. 7 shows a schematic representation of a zone system 550 with temperature control by a fan coil, according to some embodiments. The zone control system should not be considered limiting, but rather is used as an example to illustrate some of the terms described.

The fan coil is shown to receive heat transfer \dot{Q}_{HVAC} into a fluid supplying the fan coil, represented by a current source 552. In some embodiments, the heat transfer \dot{Q}_{HVAC}, can be modulated (e.g., controlled, specified, modified, etc.) by way of an electronically actuated valve. For example, the valve position, valve percent opening, or the heat transfer \dot{Q}_{HVAC}, or the flow through the valve could be an element of the control actions, u, related to the zone system 550. The amount of heat transferred into the supply fluid may have an effect on the temperature of the supply fluid, T_{sf}. The temperature of the supply fluid may be measured by the one or more sensors 456 and included in the control actions, y, of the zone system 550.

The coil capacitance 554 and the resistance to heat transfer of the coil (e.g., represented by the coil resistor 556) are shown to govern the transfer of heat from the supply fluid to the air. The coil capacitance 554 and the coil resistor 556 make a simplified coil model for the fan coil. The actual values of the simplified coil model that best fit the operational data at any given point in time will depend on many factors. For example, the coil capacitance 554 and the coil resistor 556 may depend on the temperature of the supply fluid, the temperature of the air, the rate of flow of the supply fluid, and/or the flow rate of the air across the coil. Any of these variables may be measured by the one or more sensors 456 and used as elements of an operating point for the zone system 550.

In some embodiments, elements of the operating point do not directly affect the system parameters (e.g., parameters of a model describing the behavior of the physical system). The operating point may include measurements that indirectly affect the quantities and/or are correlated with system parameters. For example, a fan speed may be used as an element of the operating point of the zone system 550 in addition to or as an alternative to the flow rate of air across the coil.

The zone system 550 is shown to include a zone resistance 558 that represents heat transfer between the supply air of the zone and the zone air mass (e.g., the air at the thermostat where the temperature is measured). The zone system 550 has a zone air capacitance 562 and a disturbance \dot{Q}_{dist} that may represent additional heat sources that are intermittent, such as heat from occupancy, electric devices operating in the zone, solar loading, etc. The zone system 550 is also shown to be affected by heat transfer from the outside air temperature 566 through an outdoor to indoor resistance 564.

In some embodiments, the equations governing the supply air temperature exiting the fan coil and the zone temperature are given by:

$$\frac{d {T}_{s a}}{d t} = \frac{1}{{C}_{c o i l}} \frac{1}{{R}_{c o i l}} {T}_{s f} - \frac{1}{{C}_{c o i l}} \frac{1}{{R}_{c o i l}} {T}_{s a} + \frac{1}{{C}_{c o i l}} {Q}_{h vac} ,$$

$$\frac{d {T}_{z n}}{d t} = \frac{1}{{C}_{z n}} \frac{1}{{R}_{z n}} {T}_{s a} + \frac{1}{{C}_{z n}} \frac{1}{{R}_{o a}} {T}_{o a} - \frac{1}{{C}_{z n}} ( \frac{1}{{R}_{z n}} + \frac{1}{{R}_{o a}} ) {T}_{z n} + \frac{1}{{C}_{z n}} {Q}_{dist} ,$$

where R_{coil} represents the coil resistor 556, C_{coil} represents the coil capacitance 554, C_{zn} represents the zone air capacitance 562, R_{zn} represents the zone resistance 558, and Rₒₐ represents the outdoor to indoor resistance 564.

For the zone system 550, many definitions of the set of parameters are possible. For example, the set of parameters may be defined as θ=[R_{coil}, C_{coil}, C_{zn}, R_{zn}, Rₒₐ]. However, it may be more convenient to represent the set of parameters as

$$θ = [ \frac{1}{{R}_{c o i l}} , \frac{1}{{C}_{c o i l}} , \frac{1}{{C}_{z n}} , \frac{1}{{R}_{z n}} , \frac{1}{{R}_{o a}} ]$$

or in terms of the capacitances and three time constants as

$$θ = [ \frac{1}{{τ}_{c o i l}} , \frac{1}{{τ}_{z n}} , \frac{1}{{τ}_{o a}} , \frac{1}{{C}_{z n}} , \frac{1}{{C}_{c o i l}} ] ,$$

where a time constant is equal to the product of a capacitance and a resistance. As stated previously, the parameters (e.g., especially R_{coil}, C_{coil}, R_{zn} or those derived from R_{coil}, C_{coil}, R_{zn}) are dependent on the fluid flow and/or air flow through the coil. The parameter-based update and control system 500 may be applied so that the parameters are updated as a function of an operating point. For example, the zone system 550 may use a measured fluid flow and a measured air flow to define an operating point. Additionally or alternatively, the valve opening and/or the fan speed may be used as elements of the operating point.

During the training mode, the parameter-based update and control system 500 may determine a grid of values for which to identify the sets of parameters. For example, the operating point may be the fractional opening of the coil valve, CLGₒ, and the fractional speed of the fan, FANₛₚ as in:

$$q = [ {CLG}_{o} , {FAN}_{s p} ]$$

The model manager 520 may generate a grid of equally spaced operating points within the 2-dimensional space of the operating point q. For example, the fractional amounts of 0.25, 0.5, 0.75, and 1.00 can be used in both dimensions for a total of sixteen interpolation operating points. For each of the sixteen interpolation operating points, the data filter 526 may gather training data that satisfies a proximity condition with the interpolation operating point. The model identifier 522 may then determine a corresponding set of parameters (e.g., θᵢ=[R_{coil,i}, C_{coil,i}, C_{zn,i}, R_{zn,i}, R_{oa,i}]) for the interpolation operating point and store the pair in the model storage 530.

During the control mode, the parameter-based update and control system 500 may determine a current operating point (or a predicted future operating point) based on measurements of the fractional opening of the coil valve, CLGₒ, and the fractional speed of the fan, FANₛₚ. The interpolator 512 may acquire the interpolation operating points and the interpolation sets of parameters and perform interpolation to determine a current set of parameters (or predicted future set of parameters) for the current operating point. The interpolator 512 may also perform extrapolation as necessary (e.g., if either fraction amount of the operating point is less than 0.25). The current set of parameters may then be used by the model-based controller 514 to determine an appropriate control action for the fan coil system. For example, the model-based controller 514 may calculate a new coil opening, fan speed, supply air temperature setpoint, etc.

In some embodiments, the current set of parameters is updated based on a schedule provided by the model update scheduler 516. The model update scheduler 516 may determine a next time to update the current set of parameters (e.g., perform interpolation again) based on a time constant of the system. For the zone system 550, the time until the next update may be based on any of the time constants τ_{coil}, τ_{zn}, or τₒₐ. Additionally or alternatively, the model update scheduler 516 may update the current set of parameters when the current operating point q=[CLGₒ, FANₛₚ] has changed by greater than a threshold amount.

Coil models for which the parameters do not depend on flow through the coil or air flow across the coil may be available. However, such coil models may be nonlinear and/or rely on iterative solving techniques (e.g., there is no analytical solution). Such models may take a prohibitive amount of time to iteratively solve when used inside an optimization algorithm. However, such a model may be used by the simulator 532 to generate training data to calculate interpolation sets of parameters for which there is only a small amount of data. For example, the simulator 532 may generate data until a data threshold is achieved for each interpolation operating point (e.g., the data filter 526 returns an acceptable amount of data for the interpolation operating point).

In some embodiments, it may be possible to determine the interpolation sets of parameters without performing identification using the model identifier 522. For example, a linearization technique such as Taylor series expansion may be used to directly find the sets of parameters for different operating points. The model for zone system 550 may be alternatively written in terms of the fractional opening of the cooling coil as in:

$$\frac{d {T}_{s a}}{d t} = \frac{1}{{C}_{c o i l}} \frac{{CLG}_{o}}{{R}_{coil , max}} {T}_{s f} - \frac{1}{{C}_{c o i l}} \frac{{CLG}_{o}}{{R}_{coil , max}} {T}_{s a} + \frac{1}{{C}_{c o i l}} {Q}_{h vac} ,$$

$$\frac{d {T}_{z n}}{d t} = \frac{1}{{C}_{z n}} \frac{1}{{R}_{z n}} {T}_{s a} + \frac{1}{{C}_{z n}} \frac{1}{{R}_{o a}} {T}_{o a} - \frac{1}{{C}_{z n}} ( \frac{1}{{R}_{z n}} + \frac{1}{{R}_{o a}} ) {T}_{z n} + \frac{1}{{C}_{z n}} {Q}_{dist} ,$$

where R_{coil,max} is the maximum value of the coil resistor 556. The system equations above are nonlinear due to the product of the CLGₒ and Tₛₐ, which represent both a controlled and manipulated variable. Instead of performing parameter identification, it is possible to find a linearization of the system model:

$$\frac{d {T}_{s a}}{d t} \approx - \frac{C L {G}_{O , 0}}{{R}_{coil , max} {C}_{coil}} {T}_{s a} + \frac{{T}_{sa , 0} - {T}_{s f}}{{R}_{coil , max} {C}_{coil}} C L {G}_{O} + \frac{1}{{C}_{c o i l}} {Q}_{h v a c} - \frac{{T}_{sa , 0} C L {G}_{O , 0}}{{R}_{coil , max} {C}_{coil}}$$

and generate interpolation sets of parameters from the linearized equation.

In some embodiments, the zone system 550 is controlled using one or more parameter-based update and control system 500 using a cascaded architecture. For example, a zone controller may be configured to adjust a setpoint of the supply air temperature, Tₛₐ, based on the error between the zone temperature and the zone temperature setpoint, and a coil controller may be configured command actuators (e.g., adjust a valve position) based on the difference between the supply air setpoint and the supply air temperature.

### Operational Flows

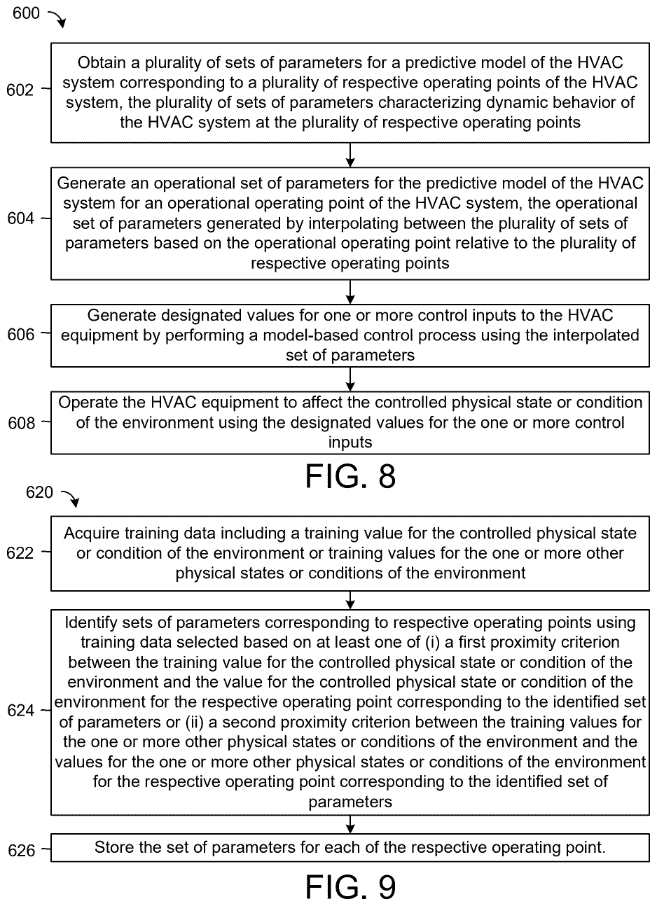

FIG. 8 shows a flow of operations 600 for performing model-based control to affect a controlled physical state or condition of an environment using interpolation-based parameter updates, according to some embodiments. The parameter-based update and control system 500 may perform the flow of operations 600 using the various instructions and components described herein.

The flow of operations 600 may include obtaining a plurality of sets of parameters for a predictive model of the HVAC system corresponding to a plurality of respective operating points of the HVAC system, the plurality of sets of parameters characterizing dynamic behavior of the HVAC system at the plurality of respective operating points in operation 602. The operation 602 may include acquiring the interpolation sets of parameters and the respective interpolation operating points from the model storage 530. The model storage 530 may have been previously populated during a training mode of operation wherein the interpolation sets of parameters were identified using training data related to the respective interpolation operating points. The flow of operations for model training is described in more detail with reference to FIG. 9.

The flow of operations 600 may include generating an operational set of parameters for the predictive model of the HVAC system for an operational operating point of the HVAC system, the operational set of parameters generated by interpolating between the plurality of sets of parameters based on the operational operating point relative to the plurality of respective operating points in operation 604. The plurality of sets of parameters (e.g., the interpolation sets of parameters) and the plurality of respective operating points (e.g., the respective interpolation operating points) found in operation 602 may be provided to interpolator 512. The interpolator 512 may perform interpolation and/or extrapolation as described herein to obtain the operational set of parameters that corresponds to an operational operating point. The operational set of parameters can be used to describe the behavior of the system under control proximate to the operational operating point and be used in a model-based control process (e.g., as performed by the model-based controller 514).

The flow of operations 600 may include generating designated values for one or more control inputs to the HVAC equipment by performing a model-based control process using the interpolated set of parameters in operation 606. For example, the operational set of parameters generated in operation 604 may be used by the model-based controller 514 to generate the designated values for the one or more control inputs. The flow of operations 600 may also include operating the HVAC equipment to affect the controlled physical state or condition of the environment using the designated values for the one or more control inputs in operation 608. The designated values for the one or more control inputs may be converted into electric control signals and communicated to actuators of the building equipment described herein and/or communicated to other BMS controllers 12 prior to the building equipment.

In some embodiments, the flow of operations 600 is scheduled to be performed again at a time in the future based on the operational set of parameters generated in operation 604. For example, the operational set of parameters may include or represent a time constant that may be used to determine an appropriate time to next update the operational set of parameters. In some embodiments, the operations 606-608 are repeated a number of times with the same operational parameters. The operations 606-608 may repeat based on a control period, whereas the operations 602 and 604 may be added at the times determined by the model update scheduler 516 based on the operational set of parameters.

The flow of operations 600 provides a method by which a complex system may be controlled using a model-based control algorithm with decreased computational effort. The behavior of the system under control is represented locally by a simple model in a region near the current operating point.

FIG. 9 shows a flow of operations 620 for determining a plurality of sets of parameters describing the behavior of a system under control proximate to a plurality of respective operating points, according to some embodiments. The plurality of sets of parameters may be the interpolation sets identified of found by the model identifier 522 for respective interpolation operating points (e.g., the plurality of respective operating points).

The flow of operations 620 may include acquiring training data including a training value for the controlled physical state or condition of the environment or training values for the one or more other physical states or conditions of the environment in operation 622. The training data acquired in operation 622 may include all the training data saved by the training data storage 524 of the parameter-based update and control system 500.

The flow of operations 620 may include identifying sets of parameters corresponding to respective operating points using training data selected based on at least one of (i) a first proximity criterion between the training value for the controlled physical state or condition of the environment and the value for the controlled physical state or condition of the environment for the respective operating point corresponding to the identified set of parameters or (ii) a second proximity criterion between the training values for the one or more other physical states or conditions of the environment and the values for the one or more other physical states or conditions of the environment for the respective operating point corresponding to the identified set of parameters in operation 624. The data filter 526 may select training data that is related to a respective operating point. The selected data may be used to identify the set of parameters that corresponds to the respective operating point by the model identifier 522. The data filter 526 may select training data based on the variables included in an operating point. The operating point may include any measured variables and/or actuated variables including the controlled physical state or condition (e.g., controlled by the model-based controller 514 to maintain a specific value) or any other physical state or condition of the building. The data filter 526 may select data based on a proximity criterion between the variables or conditions that make up the operating point and the same variables or conditions in the training data. After the set of parameters is identified for a respective operating point, the set of parameters may be stored. In an operation 626, the set of parameters for each of the respective operating points are stored (e.g., in the model storage 530).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for controlling heating, ventilation, and air conditioning (HVAC) equipment of a HVAC system to affect a controlled physical state or condition of an environment, the method comprising:
obtaining a plurality of sets of parameters for a predictive model of the HVAC system corresponding to a plurality of respective operating points of the HVAC system, the plurality of sets of parameters characterizing dynamic behavior of the HVAC system at the plurality of respective operating points;
generating an interpolated set of parameters for the predictive model of the HVAC system for an interpolation operating point of the HVAC system, the interpolated set of parameters generated by interpolating between the plurality of sets of parameters based on the interpolation operating point relative to the plurality of respective operating points;
generating designated values for one or more control inputs to the HVAC equipment by performing a model-based control process using the interpolated set of parameters; and
operating the HVAC equipment to affect the controlled physical state or condition of the environment using the designated values for the one or more control inputs.

2. The method of claim 1, wherein generating the designated values of the one or more control inputs comprises performing a model predictive control process.

3. The method of claim 1, wherein an operating point of the plurality of respective operating points comprises at least one of a value for the controlled physical state or condition of the environment or values for one or more other physical states or conditions of the environment.

4. The method of claim 3, wherein the plurality of sets of parameters corresponding to the plurality of respective operating points are determined using training data comprising:
a training value for the controlled physical state or condition of the environment; or
training values for the one or more other physical states or conditions of the environment,
wherein the training data used to determine an identified set of parameters of the plurality of sets of parameters is selected based on at least one of (i) a first proximity criterion between the training value for the controlled physical state or condition of the environment and the value for the controlled physical state or condition of the environment for the respective operating point corresponding to the identified set of parameters or (ii) a second proximity criterion between the training values for the one or more other physical states or conditions of the environment and the values for the one or more other physical states or conditions of the environment for the respective operating point corresponding to the identified set of parameters.

5. The method of claim 4, further comprising generating at least a portion of the training data by simulating a nonlinear system representing at least one of the HVAC equipment or the environment.

6. The method of claim 3, wherein generating the interpolated set of parameters for the predictive model comprises generating a hyperplane in an n-dimensional space of the operating point.

7. The method of claim 1, wherein obtaining the plurality of sets of parameters for the predictive model comprises optimizing a system identification objective function.

8. The method of claim 1, the method further comprising intermittently updating the interpolated set of parameters for the predictive model.

9. The method of claim 8, the method further comprising:
calculating a time constant of the predictive model based on the interpolated set of parameters for the predictive model; and
determining a next time the interpolated set of parameters for the predictive model are to be updated based on the time constant.

10. A heating, ventilation, and air conditioning (HVAC) system to affect a controlled physical state or condition of an environment, the HVAC system comprising:
one or more memory devices having instructions stored thereon that, when executed by one or more processors, cause the one or more processors to perform operations comprising:
calculating estimated values of one or more parameters of a model that relates one or more control inputs and a set of physical states or conditions to the controlled physical state or condition of the environment by interpolating the one or more parameters of the model based at least on (i) current values of the set of physical states or conditions and (ii) a set of values of the one or more parameters of the model for respective operating values of the set of physical states or conditions, wherein the set of physical states or conditions comprises states or conditions of at least one of HVAC equipment or the environment;
generating designated values for the one or more control inputs to the HVAC equipment by performing a model-based control process using the estimated values of the one or more parameters; and
operating the HVAC equipment to affect the controlled physical state or condition of the environment using the designated values for the one or more control inputs.

11. The HVAC system of claim 10, wherein generating the designated values of the one or more control inputs comprises performing a model predictive control process.

12. The HVAC system of claim 10, wherein the set of values of the one or more parameters of the model for the respective operating values of the one or more control inputs or the respective operating values of the set of physical states or conditions are determined using training data comprising:
training values of the one or more control inputs;
training values of the set of physical states or conditions; and
training values of the controlled physical state or condition of the environment,
wherein the training values of the set of physical states or conditions satisfy a second proximity criterion with the respective operating values of the set of physical states or conditions.

13. The HVAC system of claim 12, the operations further comprising generating at least a portion of the training data by simulating a nonlinear system representing at least one of the HVAC equipment or the environment.

14. The HVAC system of claim 10, wherein the model that relates the one or more control inputs and the set of physical states or conditions to the controlled physical state or condition of the environment comprises at least two submodels, wherein a first submodel of the at least two submodels generates a setpoint or a constraint that is an input to a second submodel of the at least two submodels.

15. The HVAC system of claim 10, wherein the HVAC equipment comprises at least two controllers, wherein a first controller of the at least two controllers generates a setpoint or a constraint that is an input to a second controller of the at least two controllers.

16. The HVAC system of claim 15, the operations further comprising:
calculating a time constant of the model based on the estimated values of the one or more parameters of the model; and
determining a next time the estimated values are to be updated based on the time constant.

17. A heating, ventilation, and air conditioning (HVAC) system to affect a controlled physical state or condition of an environment, the HVAC system comprising:
one or more memory devices having instructions stored thereon that, when executed by one or more processors, cause the one or more processors to perform operations comprising:
calculating estimated values of one or more parameters of a model that relates one or more control inputs and a set of physical states or conditions to the controlled physical state or condition of the environment by interpolating the one or more parameters of the model;
determining a next time to update the estimated values of the one or more parameters of the model based on the estimated values of the one or more parameters;
generating designated values for the one or more control inputs to HVAC equipment by performing a model-based control process using the estimated values of the one or more parameters; and
operating the HVAC equipment to affect the controlled physical state or condition of the environment using the designated values for the one or more control inputs.

18. The HVAC system of claim 17, wherein interpolating the one or more parameters of the model is based at least on a set of values of the one or more parameters of the model for respective operating values of the set of physical states or conditions.

19. The HVAC system of claim 17, wherein generating the designated values of the one or more control inputs comprises performing a model predictive control process.

20. The HVAC system of claim 17, wherein the set of values of the one or more parameters of the model for the respective operating values of the set of physical states or conditions is found using training data comprising:
training values of the one or more control inputs;
training values of the set of physical states or conditions; and
training values of the controlled physical state or condition of the environment,
wherein the training values of the set of physical states or conditions satisfy a second proximity criterion with the respective operating values of the set of physical states or conditions.
